(19) United States
(12) Patent Application Publication
(10) Pub. No.: US 2008/0278462 A1
(43) Pub. Date: Nov. 13, 2008

(54) PORTABLE ELECTRONIC DEVICE WITH TOUCH SCREEN

(75) Inventor: JEN-TSORNG CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/950,383

(22) Filed: Dec. 4, 2007

(30) Foreign Application Priority Data
May 9, 2007 (CN) 200710200594.0

(51) Int. Cl. G06F 3/033

(52) U.S. Cl. 345/179

(57) ABSTRACT

A portable electronic device with a simulation touch screen includes a main body, a display screen, a stylus, a camera unit and a processing unit. The display screen is mounted on the main body. The stylus is used for controlling movement of a cursor on the display screen. The stylus has a light source for generating a light spot on the display screen. The stylus is configured for controlling movement of a cursor on the display screen. The camera unit is electrically connected with the main body and faces the display screen. The camera unit is configured for capturing images of the display screen and the light spot thereon. The processing unit is mounted in the main body and electronically coupled to the camera unit.

### BACKGROUND

1. Technical Field

The present invention relates to portable electronic devices, and particularly to a portable electronic device with a simulation touch screen.

2. Description of Related Art

Currently, portable electronic devices, such as portable computers, personal digital assistants (PDAs), mobile phones, etc., are becoming indispensable products for people in modern life. Input devices for use in the portable electronic devices are known in the art. The input devices are used to input data into a portable electronic device.

The input device may comprise a touch screen. A typical touch screen senses the presence of an object such as a tip of a finger or other object, for example a stylus, at an active surface area of the touch screen. The advantage of the touch screen is that the user can directly point to an item of interest on the screen instead of having to use a mouse or other input devices. A conventional touch screen, e.g. capacitive touch screen or resistive touch screen, generally includes a common display panel and a multilayer structure overlaid thereon. This reduces the brightness of the light emitted from the touch screens.

What is needed, therefore, is a portable electronic device with a simulation touch screen with better visibility.

### SUMMARY

In a present embodiment, a portable electronic device with a simulation touch screen includes a main body, a display screen, a stylus, a camera unit and a processing unit. The display screen is mounted on the main body. The stylus is used for controlling movement of a cursor on the display screen. The stylus has a light source for generating a light spot. The stylus is configured for controlling movement of a cursor on the display screen. The camera unit is electrically connected with the main body and faces the display screen. The camera unit is configured for capturing images of the display screen and the light spot thereon. The processing unit is mounted in the main body and electronically coupled to the camera unit. The processing unit is configured for receiving the images from the camera unit at a predetermined frequency, analyzing changes between the images caused by a movement of the stylus, processing and transforming the changes into a control signal to control movement of the cursor on the display screen in response to the movement of the stylus.

Other advantages and novel features of the present invention will become more apparent from the following detailed description of present embodiment when taken in conjunction with the accompanying drawings.

### BRIEF DESCRIPTION OF THE DRAWINGS

Many aspects of the portable electronic device with a simulation touch screen can be better understood with reference to the following drawings. The components in the drawing are not necessarily drawn to scale, the emphasis instead being placed upon clearly illustrating the principles of the present portable electronic device with a simulation touch screen. Moreover, in the drawings, like reference numerals designate corresponding parts throughout the several views.

FIG. 1 is schematic view of a portable electronic device according to a present embodiment of the present invention, wherein the portable electronic device includes a stylus;

FIG. 2 is schematic view of the portable electronic device in FIG. 1 in another state;

FIG. 3 is schematic, cross-sectional view of the stylus of the portable electronic device in FIG. 1;

FIG. 4 is schematic view of another stylus applied in the portable electronic device in FIG. 1 according to a second present embodiment; and

FIG. 5 is schematic view of a working process of the portable electronic device in FIG. 1 according to a third present embodiment.

### DETAILED DESCRIPTION OF THE EMBODIMENTS

Embodiments of the present portable electronic device with a simulation touch screen will now be described in detail below and with reference to the drawings.

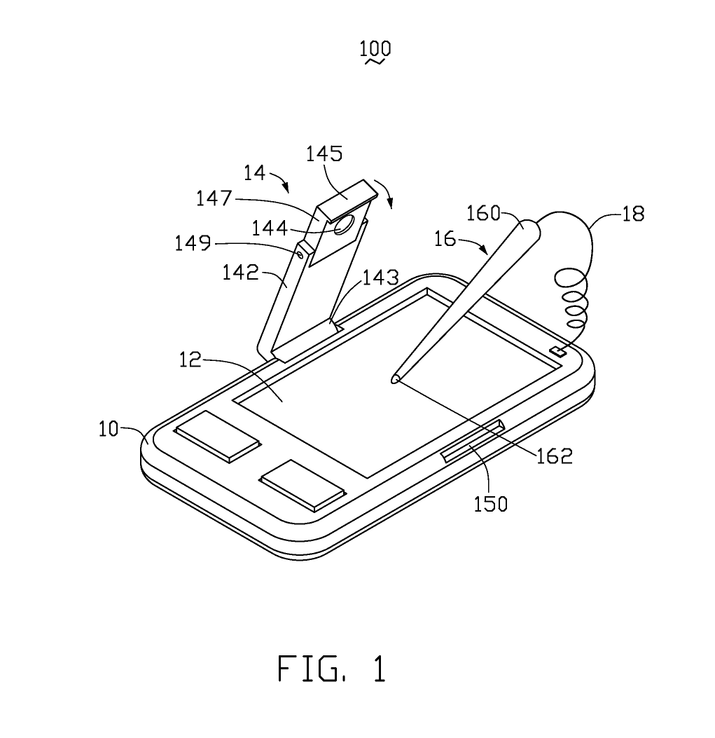

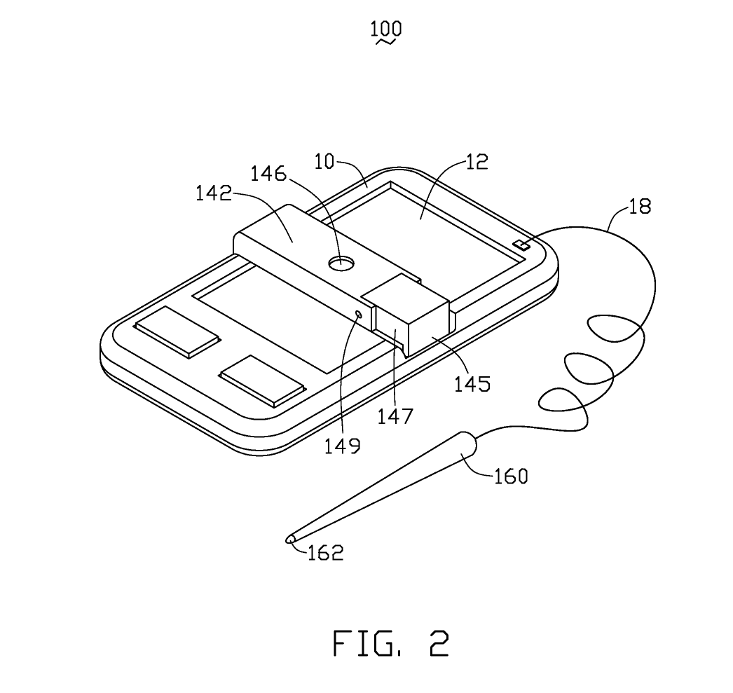

Referring to FIGS. 1 and 2, a portable electronic device 100 according to a first embodiment is shown. In the present embodiment, the portable electronic device 100 is a mobile phone. The portable electronic device 100 includes a main body 10, a display screen 12, a camera module 14 and a stylus 16. The portable electronic device 100 also can be a portable computer, a PDA, etc.

The main body 10 includes a case (not labeled) and a central processing unit 32 (referring to FIG. 6) and a printed circuit board housed in the case. The central processing unit 32 is used for processing data, etc. The printed circuit board is configured for electrically connecting the functional units, e.g. a display unit, the central processing unit, etc., with each other. The display screen 12 is arranged on the front surface of the main body 10. The display screen 12 can be selected from a group consisting of a liquid crystal display (LCD), an E-paper display, an organic light-emitting diode display, etc. In the present embodiment, the display screen 12 is an LCD with a vertical scanning frequency of 60 heltz. Generally, the display screen 13 can be used to display time, messages, images, etc.

The camera module 14 is connected with the main body 10. In the present embodiment, the camera module 14 includes a first connection member 142, a second connection member 147, a first camera unit 144 and a second camera unit 146. One distal end of the first connection member 142 are pivotally connected with one side of the main body 10 via a shaft 143. The other end of the first connection member 142 is pivotally connected with one distal end of the second connection member 147 via a shaft 149. A latching notch 150 is defined at another side of the main body 10 opposite to the shaft 143. A protrusion 145 is formed at the other distal end of the second connection member 147 opposite to the shaft 149. The first connection member 142 and the second connection member 147 can rotate relative to the shaft 143 and the shaft 149 relatively thereby, latching the protrusion 145 with the latching notch 150.

The first camera unit 144 is installed in the second connection member 142 adjacent to the protrusion 145 and the shaft 143. The second connection member 142 can rotate relative to the first connection member 142 thereby, the first camera unit 144 faces the display screen 12. The first camera unit 144 is configured for capturing a real time images of the display screen 12. In the present embodiment, a frame frequency of the first camera unit 144 is 30 frames per second. The second camera unit 146 is installed in the first connection member 142. The second camera unit 146 is configured for personal use to capture images of scenery, portrait etc. It is to be understood that the camera module 14 also can be connected with the main body in other manners.

The stylus 16 includes a stylus main body 160 with a cavity therein and a light source 162 at a distal end of the stylus main body 160. The stylus 16 is electrically connected with the main body 10 by a lead 18, which supplies electric energy to the light source 162. The light source 162 is configured for emitting visible light with a flicker frequency of 20 hertz.

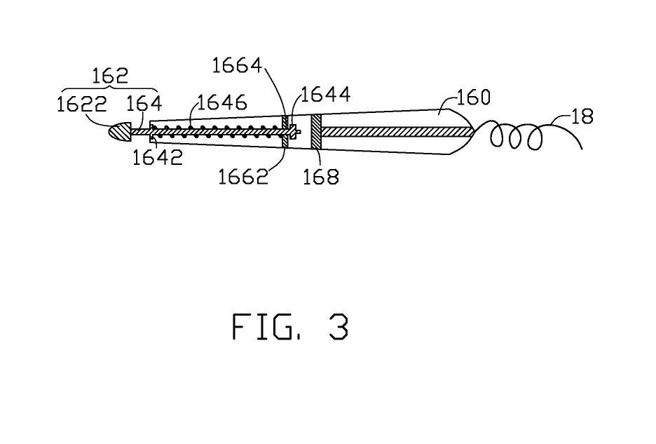

Referring to FIG. 3, an power supply contact 168 is fixed to the inner wall of the stylus main body 160. The power supply contact 168 is electrically connected with the lead 18. The light source 162 includes a light emitting diode 1622 and an electrical lead 164 with one end thereof electrically connecting with the light emitting diode 1622, wherein the light emitting diode 1622 is round-shaped for generating a light-spot.

A first flange portion 1644 is formed at the other end of the electrical lead 164. A second flange portion 1642 extends at the periphery of the electrical lead 164. The second flange portion 1642 is formed between the light emitting diode 1622 and the first flange portion 1644. The first flange portion 1644 and the second flange portion 1642 both are made from conductive material. A partition plate 1662 is attached to the inner wall of the stylus main body 160. A through hole 1664 is defined in the centre of the partition plate 1662. The electrical lead 164 inserts through the through hole 1664 of the partition plate 1662. The first flange portion 1644 and the second flange portion 1642 are separately located at opposite sides of the partition plate 1662. A diameter of the through hole 1664 of the partition plate 1662 is smaller than a diameter of the periphery of the first flange portion 1644. A spring 1646 is coiled around the electrical lead 164. The spring 1646 is disposed between the partition plate 1662 and the second flange portion 1642. The spring 1646 can be compressed so as to firmly connect the light source 162 with the stylus main body 160.

When applying a force on the light source 162 in a direction away from the power supply contact 168, the second flange portion 1642 compresses the spring 1646 and the first flange portion 1644 moves towards the power supply contact 168 until it reaches the power supply contact 168. Then, electric current is transmitted to the light emitting diode 1622 thus, the light emitting diode 1622 is turned on. On the contrary, releasing the force on the light source 162 makes the second flange portion 1642 move away from the power supply contact 168, and thus the light emitting diode 1622 is turned off. The force on the light source 162 can be made via pressing the light emitting diode 1622 on the display screen 12.

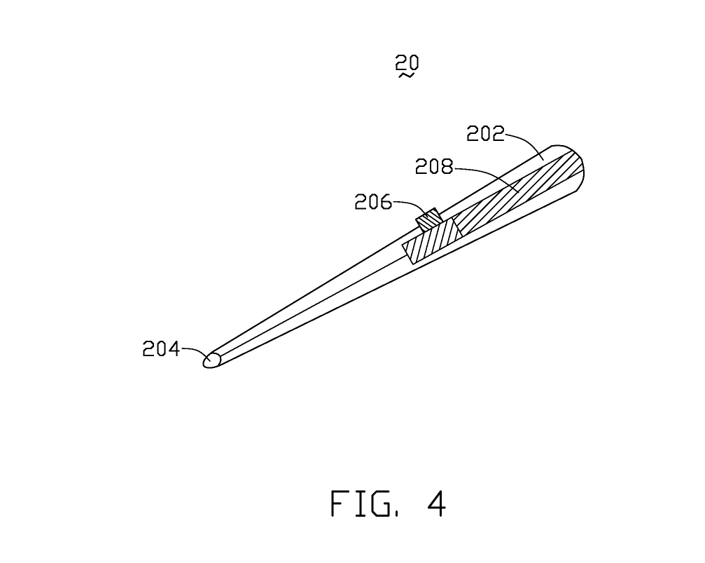

Referring to FIG. 4, another stylus 20 is illustrated in accordance with a second embodiment. In the present embodiment, a stylus 20 includes stylus main body 202, a round-shaped tip portion 204 located at a distal end of the stylus main body 202 and a switch button 206 mounted at the outer side of the stylus main body 202. The round-shaped tip portion 204 is configured for generating a light-spot. The switch button 206 is configured for controlling the round-shaped tip portion 204 to be in on/off position by pressing/releasing. A battery 208 is disposed in the stylus main body 202 for supplying electrical energy to the round-shaped tip portion 204. The round-shaped tip portion 204 can also be a laser source.

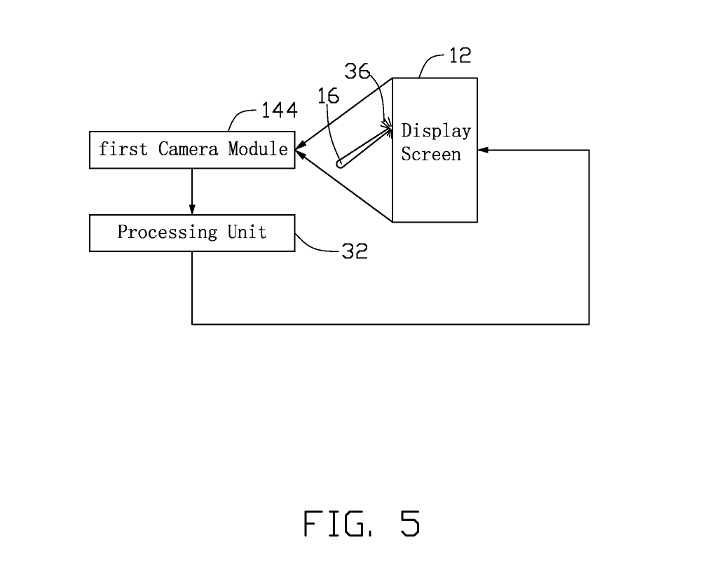

Referring to FIGS. 3 and 5, the portable electronic device 100 further includes a processing unit 32. A working process of the portable electronic device 100 is illustrated with reference to a third embodiment. When the round-shaped tip portion 204 emits visible light, a working process of the portable electronic device 100 is described in detail as follows:

Step 1: an image of the display screen 12 is captured by the first camera unit 144 and is transmitted to the processing unit 32. The image is processed and analyzed by the processing unit 32 to identify a position coordinate of the display screen 12 in the image. In the whole working process of the portable electronic device 100, a relative position between the first camera unit 144 and the display screen 12 is unchangeable.

Step 2: The light emitting diode 1622 of the stylus 16 touches/presses the display screen 12, so that the spring 1646 is compressed by the electrical lead 164 to drive the electrical lead 164 contact the power supply contact 168. Thus, a light-spot 36 is generated by the light emitting diode 1622. The light emitting diode 1622 is used for controlling movement of a cursor on the display screen 12. The light-spot 36 navigates in the surface region of the display screen 12 so that the cursor moves on the display screen 12. The first camera unit 144 captures a plurality of continuous frames of images including the light-spot 36.

Step 3: the images including the light-spot 36 are transmitted to the processing unit 32. The frame frequency of the first camera unit 144 (30 frames per second) is less than the Vertical Scanning Frequency of the display screen (60 hertz) and greater than the flicker frequency of the light source 162 (20 hertz). Therefore, the images of the display screen 12 are continuous, and the images of the light-spot 36 are discontinuous. Thus, the processing unit 32 identifies the light-spot 36 and its position coordinate in the image.

Step 4: the image including the light-spot 36 are compared with the image captured in step 1, and a relative position of the light-spot 36 to the display screen 12 is analyzed with the processing unit 32. Because the first camera unit 144 takes real-time images continuously, the movement and the flicker of the light-spot 36 are identified and transformed into corresponding instructions. Thus, the stylus 16 controls the movement of the cursor on the display screen 12.

It is to be understood that the frame frequency of the first camera unit 144, the vertical scanning frequency of the display screen 12 and the flicker frequency of the light source 162 can be others, as long as the frame frequency of the first camera unit 144 is less than the Vertical Scanning Frequency of the display screen and higher than the flicker frequency of the light source 162.

When the round-shaped tip portion 204 emits infrared light, a working process of the portable electronic device 100 is described in detail as follows:

Step 1: an image containing the whole display screen 12 is taken by the first camera unit 144 and is transmitted to the processing unit 32. The image is processed and analyzed by the processing unit 32 to identify a position coordinate of the display screen 12 in the image. In the whole working process of the portable electronic device 100, a relative position between the first camera unit 144 and the display screen 12 is unchanged.

Step 2: The light emitted diode 1622 of the stylus 16 touched/pressed the display screen 12, so that the spring 1646 is compressed by the electrical lead 164 to drive the electrical lead 164 contact the power supply contact 168. Thus, an infrared light-spot 36 is generated by the light emitting diode 1622. The light emitting diode 1622 is used for controlling movement of a cursor on the display screen 12. The infrared light-spot 36 navigates in the surface region of the display screen 12 so that the cursor moves on the display screen 12. The first camera unit 144 captures a plurality of continuous frames of images including the infrared light-spot 36.

Step 3: the images including the light-spot 36 are transmitted to the processing unit 32. The first camera unit 144 includes an infrared sensor (not shown) configured for sensing the infrared light-spot 36. The infrared sensor can distinguish the infrared light emitted from the light-spot 36 from the visible light emitted from the display screen 12. Thus, the processing unit 32 identifies the light-spot 36 and its position coordinate in the image.

Step 4: the image including the light-spot 36 is compared with the image taken in step 1, and the relative position of the light-spot 36 to the display screen is analyzed with the processing unit 32. Because the first camera unit 144 takes real-time images continuously, the movement and the flicker of the light-spot 36 are identified and transformed into instructions. Thus, the stylus 16 controls the movement of the cursor on the display screen 12.

The usage of the stylus 20 is similar to that of the stylus 16. The difference is that on/off position of the round-shaped tip portion 204 of the stylus 20 is controlled by pressing/releasing the switch button 206. Also, the stylus 20 can be replaced by a laser source.

It needs to be explained that the surface region of the display screen 12 includes the surface of the display screen 12 and a space adjacent to the surface of the display screen 12. The position of the light-spot 36 on the display screen 12 is a vertical projection of the light-spot 36 on the display screen.

One of the advantages of the present portable electronic device 100 is that it does not require a multi-layer structure to be mounted on the display screen 12. Thus, increase the brightness of the display screen 12. In addition, in comparison with touching the display screen 12 with fingeers, the use of the stylus 16 can decrease the chances of getting the display screen dirty.

It is understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A portable electronic device comprising:
a main body;
a display screen mounted on the main body;
a stylus for controlling movement of a cursor on the display screen, the stylus having a light source for generating a light spot on the display screen;
a camera unit electrically connected with the main body and facing the display screen, the camera unit being configured for capturing images of the display screen and the light spot thereon;
a processing unit mounted in the main body and electronically coupled to the camera unit, the processing unit being configured for receiving the images from the camera unit at a predetermined frequency, analyzing changes between the images caused by a movement of the stylus, processing and transforming the changes into a control signal to control movement of the cursor on the display screen in response to the movement of the stylus.

2. The portable electronic device as described in claim 1, wherein the light source is configured for emitting visible light toward the display screen, the visible light having a flicker frequency, the display screen having a vertical scanning frequency, and the camera unit having a frame frequency, the frame frequency being less than the vertical scanning frequency and greater than the flicker frequency.

3. The portable electronic device as described in claim 1, wherein the light source is configured for emitting infrared light, the camera unit including an infrared sensor for sensing infrared light emitted from the light source, thus capturing images of the light spot.

4. The portable electronic device as described in claim 1, wherein the stylus includes an elongated stylus main body and the light source, the light source comprising a round-shaped tip portion.

5. The portable electronic device as described in claim 1, wherein the light source is selected from a group consisting of visible light emitting diode and an infrared light emitting diode.

6. The portable electronic device as described in claim 4, wherein the stylus includes a battery disposed in the stylus main body for supplying electric energy to the light source.

7. The portable electronic device as described in claim 4, wherein the light source is electrically connected to the main body.

8. The portable electronic device as described in claim 4, wherein the stylus comprises a power supply contact for electrical connection to a power source, and a spring member for applying a force on the light source in a direction toward the power supply contact, the light source being engaged in the stylus main body and lengthwise movable therein, the light source comprising a light emitting diode, an electrical lead with a first end thereof electrically connecting with the light emitting diode and an opposite second end for electrical connection to the power supply contact.

9. The portable electronic device as described in claim 8, wherein the power supply contact is electrically connected to the main body.
